(19) United States
(12) Patent Application Publication
(10) Pub. No.: US 2013/0082537 A1
(43) Pub. Date: Apr. 4, 2013

(54) WIRELESS POWER TRANSMITTING AND RECEIVING DEVICE

(71) Applicants: Yong Hae KIM, Daejeon (KR); Sang Hoon CHEON, Daejeon (KR); Myung Lae LEE, Daejeon (KR); Seung Youl KANG, Daejeon (KR); Taehyoung ZYUNG, Daejeon (KR)

(72) Inventors: Yong Hae KIM, Daejeon (KR); Sang Hoon CHEON, Daejeon (KR); Myung Lae LEE, Daejeon (KR); Seung Youl KANG, Daejeon (KR); Taehyoung ZYUNG, Daejeon (KR)

(73) Assignee: ELECTRONICS AND TELECOMMUNICATIONS RESEARCH INSTITUTE, Daejeon (KR)

(21) Appl. No.: 13/487,760

(22) Filed: Jun. 4, 2012

(30) Foreign Application Priority Data
Sep. 29, 2011 (KR) 10-2011-0099302

(51) Int. Cl. H02J 17/00

(52) U.S. Cl. 307/104

(57) ABSTRACT

Disclosed is a wireless power transmitting and receiving device which includes a wireless power receiving device comprising a receiving coil configured to receive a non-radiated electromagnetic wave; and a frequency adjusting unit configured to adjust a resonant frequency of the receiving coil and a wireless power transmitting device comprising a transmission coil configured to generate a non-radiated electromagnetic wave by magnetic induction with a power coil; and a frequency adjusting unit configured to adjust a resonant frequency of the transmission coil. The frequency adjusting unit adjusts a resonant frequency of the receiving coil by closing a surroundings of the receiving coil by a magnetic sheet. The frequency adjusting unit adjusts a resonant frequency of the transmission coil by inserting a magnetic sheet in the transmission coil.

### CROSS-REFERENCE TO RELATED APPLICATIONS

A claim for priority under 35 U.S.C. §119 is made to Korean Patent Application No. 10-2011-0099392 filed Sep. 29, 2011, in the Korean Intellectual Property Office, the entire contents of which are hereby incorporated by reference.

### BACKGROUND

The inventive concepts described herein relate to a wireless power transmitting and receiving device.

As portable and small-sized electronic devices have been rapidly developed in recent years, there have been required techniques capable of easily charging them indoors and outdoors. Among the techniques, a wireless charging manner may take center stage instead of a wire charging manner.

As a wireless power transmitting manner, a magnetic induction manner may have been used in a transformation field. With the magnetic induction manner, power transmission efficiency may be sharply lowered according to a distance, so that the magnetic induction manner is used at a close range. Thus, there is required a technique for putting the magnetic induction manner to practical use.

### SUMMARY

A wireless power transmitting and receiving device according to embodiments of the inventive concept includes a wireless power receiving device comprising a receiving coil configured to receive a non-radiated electromagnetic wave; and a frequency adjusting unit configured to adjust a resonant frequency of the receiving coil, the frequency adjusting unit adjusting a resonant frequency of the receiving coil by closing a surroundings of the receiving coil by a magnetic sheet.

In example embodiments, the wireless power receiving device further comprises a load coil supplied with energy stored at the receiving coil by magnetic induction.

In example embodiments, the frequency adjusting unit includes a capacitor connected to the receiving coil.

In example embodiments, the receiving coil has a copper line to generate a magnetic field, and the copper line is buried at a groove of the magnetic sheet.

In example embodiments, the receiving coil has a copper line to generate a magnetic field, and the frequency adjusting unit adjusts a contact area between the copper line and the magnetic sheet.

In example embodiments, the frequency adjusting unit linearly adjusts a contact area between the copper line and the magnetic sheet.

In example embodiments, the magnetic sheet is formed of a bilayer including an adhesive substance and a magnetic substance.

In example embodiments, the magnetic substance is formed of ferrite.

A wireless power transmitting and receiving device according to embodiments of the inventive concept further includes a wireless power transmitting device comprising a transmission coil configured to generate a non-radiated electromagnetic wave by magnetic induction with a power coil; and a frequency adjusting unit configured to adjust a resonant frequency of the transmission coil, the frequency adjusting unit adjusting a resonant frequency of the transmission coil by inserting a magnetic sheet in the transmission coil.

In example embodiments, the wireless power transmitting device includes a power coil receiving a power.

In example embodiments, the frequency adjusting unit includes a capacitor connected to the transmission coil.

In example embodiments, the transmission coil has a copper line generating a magnetic field, and the copper line is buried at a groove of the magnetic sheet.

In example embodiments, the transmission coil has a copper line generating a magnetic field, and a contact area between the magnetic sheet and the copper line is adjustable.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a conceptual diagram illustrating a wireless power transmitting and receiving device according to an embodiment of the inventive concept.

FIG. 2 is a conceptual diagram illustrating a wireless power transmitting and receiving device according to an embodiment of the inventive concept.

FIG. 3 is a conceptual diagram illustrating a frequency adjusting unit in FIG. 2.

FIGS. 4 and 5 are diagrams illustrating a magnetic sheet structure according to embodiments of the inventive concept.

FIG. 6 is a graph illustrating relationship between inductance and a diameter of a copper line according to how much a copper line is surrounded by a magnetic sheet using a ferrite sheet.

FIG. 7 is a graph illustrating a variation in inductance of a copper line according to how much a copper line is closed by a magnetic sheet.

FIG. 8 is a conceptual diagram illustrating a frequency adjusting unit in FIG. 2 according to another embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section.

Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

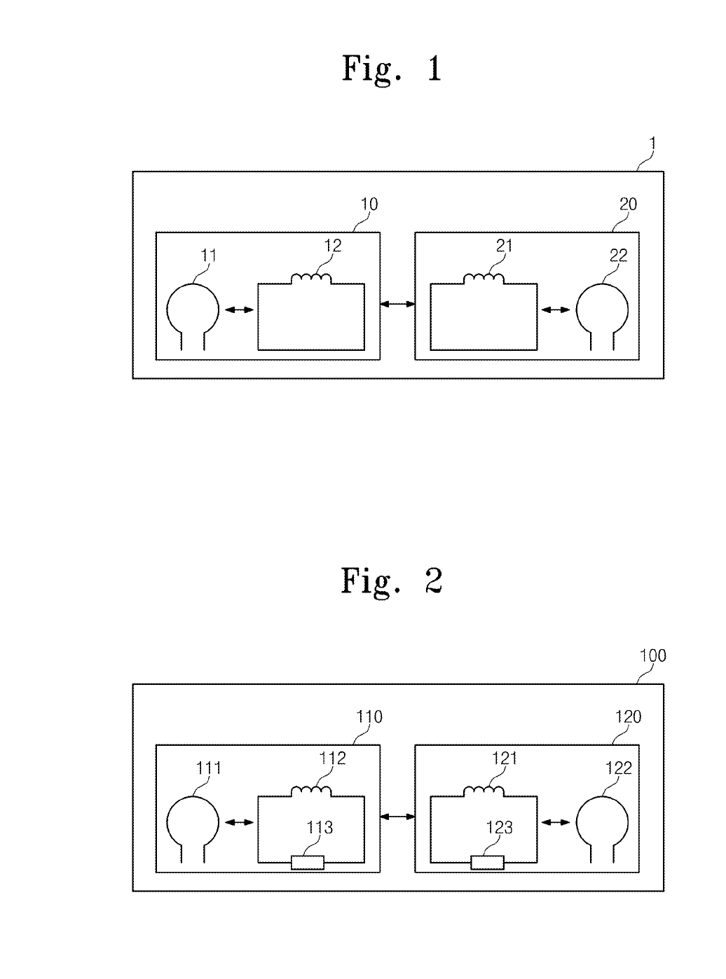

FIG. 1 is a conceptual diagram illustrating a wireless power transmitting and receiving device according to an embodiment of the inventive concept. Referring to FIG. 1, a wireless power transmitting and receiving device 1 may include a power transmitting device 10 and a power receiving device 20.

The power transmitting device 10 may include a power coil 11 and a transmission coil 12. The power transmitting device 10 may be powered by a voltage source (e.g., a solar battery, a generator, a battery, etc.) capable of generating a power. The power transmitting device 10 may transmit a power to the power receiving device 20. The power transmitting device 10 may transmit a power using an electromagnetic wave having a specific frequency. Herein, a frequency of the electromagnetic wave need not be fixed. The power transmitting device 10 may be implemented to transfer at least two or more frequencies. Further, the power transmitting device 10 may be implemented to transmit a power non-continuously. This may enable unnecessary power transmission to be prevented when no power transmission of the power transmitting device 10 is required. Thus, the power transmission efficiency may be improved.

The power coil 11 may be powered by an external device. For example, the power coil 11 may be powered by a voltage source (e.g., a solar battery, a generator, a battery, etc.). A manner of powering the power coil 11 may not be limited thereto. For example, the power coil 11 may be powered in a magnetic induction manner. Alternatively, the power coil 11 may be formed of a coil having a diameter of more than 3 mm to reduce power loss due to resistance. Further, a turn number of the power coil 11 may be less to reduce power loss.

The transmission coil 12 may be received from a power from the power coil 11. The transmission coil 12 may be configured to resonate by magnetic induction with the power coil 11 under an inherent frequency so as to generate a non-radiated electromagnetic wave. Thus, a resonation frequency of the transmission coil 12 may be equal to that of the power coil 11. The transmission coil 12 may be placed to be close to the power coil 11 for the power transmission efficiency from the power coil 11. In example embodiments, the transmission coil 12 may be formed of a coil having a diameter of more than 3 mm to reduce power loss due to resistance.

The power receiving device 20 may include a receiving coil 21 and a load coil 22.

The receiving coil 21 may receive a non-radiated electromagnetic wave from the power transmitting device 10. The receiving coil 21 may resonate at the same frequency as the transmission coil 12, and may be supplied with a power via magnetic coupling with the transmission coil 12.

The load coil 22 may receive an energy stored at the receiving coil 21. The load coil 22 may be supplied with a power from the receiving coil 21 in a magnetic induction manner. For this reason, it is desirable to place the load coil 22 at a location adjacent to the receiving coil 21.

As described above, the wireless power transmitting and receiving device may be configured such that a power is transmitted between the power transmitting device 10 and the power receiving device 20 in a resonant wireless power transmission manner. When a power is transmitted according to a conventional electromagnetic induction manner, the efficiency may be sharply lowered according to a distance. On the other hand, when a power is transmitted according to the resonant wireless power transmission technique being a non-radiated energy transmission technique, the transmission efficiency may be reduced linearly according to a distance. Thus, the resonant wireless power transmission manner of the inventive concept may be effective in long power transmission compared with the electromagnetic induction manner.

Further, the non-radiated wireless energy transmission of the inventive concept may be made by evanescent wave coupling where an electromagnetic wave is transferred from one medium to the other medium through a short electromagnetic field when the two mediums resonate at the same frequency. Thus, energy may be transferred only when resonant frequencies of two mediums are identical to each other. Since unused energy is absorbed by the electromagnetic field without radiation into an air, the non-radiated wireless energy transmission manner may be efficient. Thus, compared with other electromagnetic wave transmission techniques, the non-radiated wireless energy transmission technique of the inventive concept may scarcely affect peripheral electronic devices or human bodies.

However, since the protect standard for the human body of the electric field and a magnetic field associated with each frequency is enacted in connection with the health hazards, it is desirable to use a resonant frequency band allowing the maximum output that does not get out of the standard. As a frequency band becomes high, the maximum output power on a frequency band may be lowered sharply. In general, restriction on about 10 MHz may be heavy. However, compared with restriction on 10 MHz, restriction on about 1 MHz may be reduced to 1/10. Thus, it is desirable to use a resonant frequency lower than 1 MHz in terms of restriction of a transmission power.

Inductance and capacitance of the coils 12 and 21 may be adjusted to use a desired resonant frequency band. A resonant frequency may be in reverse proportion to the square root of the product of inductance and capacitance of a coil. Thus, the larger the capacitance and inductance of the coils 12 and 21, the lower a resonant frequency band to be used.

However, if a low resonant frequency band is realized only using inductance and capacitance of a coil itself, a length of a copper line may lengthen excessively. Further, a coil may have an excessive number of turns. This may make a coil become larger in size. But, a coil below 7 cm must be used to apply a wireless transmission technique to a handheld device. Further, internal resistance of a copper line as well as a size of a coil may increase. This may mean that a transmission system has high loss.

A resonant frequency can be adjusted by lowering resistance via a copper line having one turn and connecting an electrolytic capacitor having a large capacitance value. However, since a capacitor with a large capacity is large in size and generates a much amount of leakage current, the efficiency may not be good.

FIG. 2 is a conceptual diagram illustrating a wireless power transmitting and receiving device according to an embodiment of the inventive concept. A wireless power transmitting and receiving device 100 in FIG. 2 may be substantially equal to that in FIG. 1 except that a frequency adjusting unit 123 is added.

Referring to FIG. 2, a frequency adjusting unit 123 may be connected with a receiving coil 121. The frequency adjusting unit 123 may be configured to adjust inductance and capacitance of the receiving coil 121. The frequency adjusting unit 123 may adjust a resonant frequency of the receiving coil 121 without an excessive increase in the receiving coil 121 in size.

The receiving coil 121 of the wireless power transmitting and receiving device 100 in FIG. 2 may be smaller in size than that of a receiving coil 21 of a wireless power transmitting and receiving device 10 in FIG. 2. Further, since a copper line of the receiving coil 121 need not lengthen for inductance, the receiving coil 121 may have a less turn number to reduce a total of resistance. In example embodiments, the receiving coil 121 may be configured to have three or four turns such that a total of resistance becomes less than 0.5Ω. The above-described reference may be applied to a frequency adjusting unit 123 of a power receiving device 120. For ease of description, a frequency adjusting unit 123 of a power receiving device 120 will be more fully described with reference to accompanying drawings.

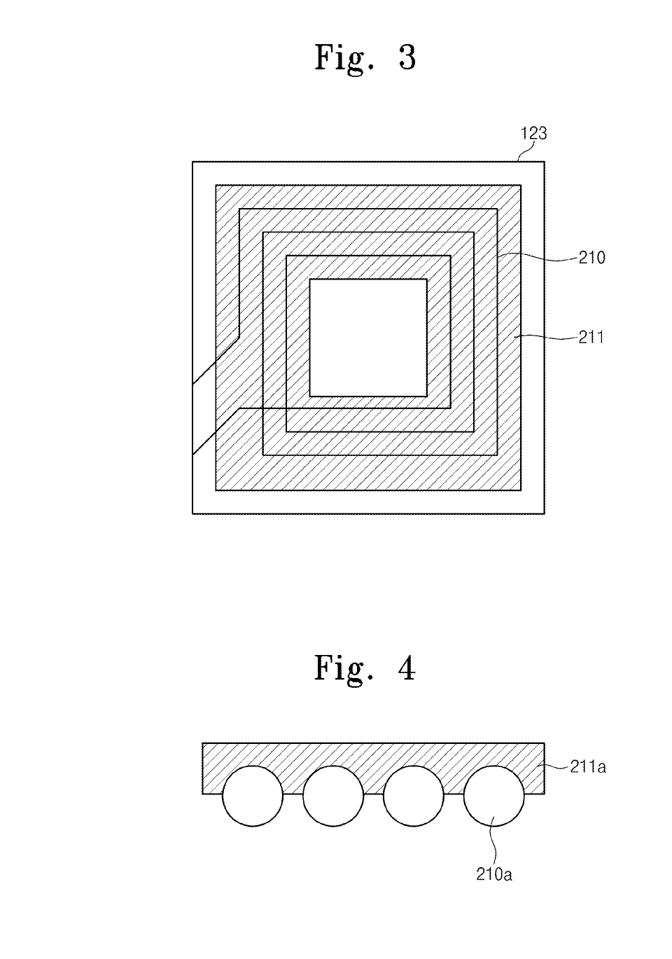

FIG. 3 is a conceptual diagram illustrating a frequency adjusting unit in FIG. 2. A frequency adjusting unit 123 may include a magnetic sheet 211. The magnetic sheet 211 may be formed to surround around a copper line 210 of a receiving coil 121. The magnetic sheet 211 may adjust inductance of the receiving coil 121.

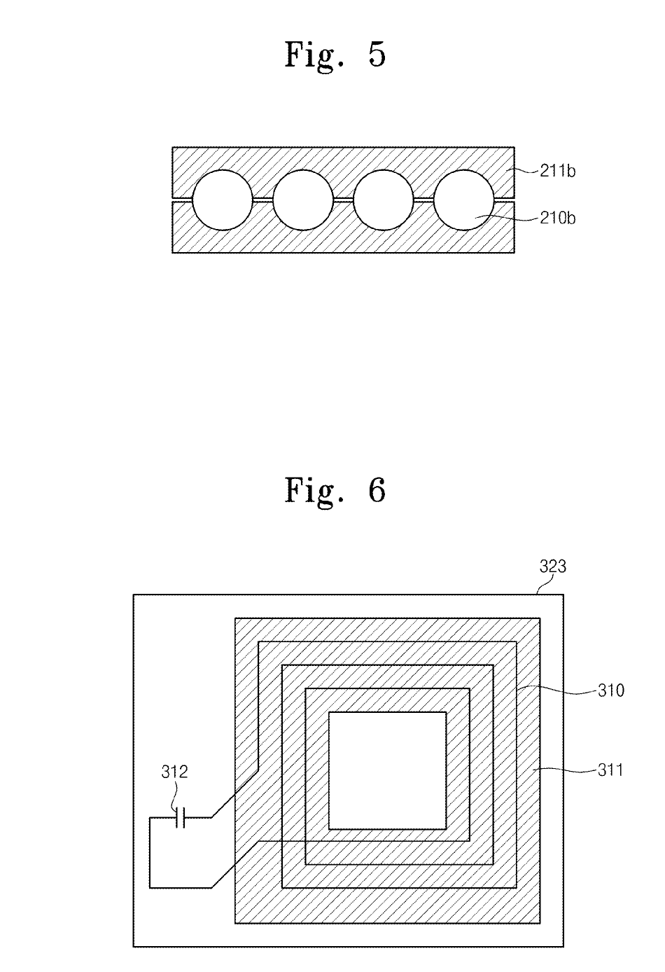

FIGS. 4 and 5 are diagrams illustrating a magnetic sheet structure according to embodiments of the inventive concept. In FIG. 4, there is illustrated a magnetic sheet 211a that is configured to surround one surface of a copper line 210a.

In FIG. 5, there is a magnetic sheet 211b that is configured to surround both surfaces of a copper line 210b. Inductance of the copper line 210a/210b may vary according to how much the copper line 210a/210b is surrounded by the magnetic sheet 211a/211b. Inductance of a resonator may increase twice in maximum when one surface of the copper line 210a/210b is surrounded by the magnetic sheet 211a/211b.

In the event that both surfaces of the copper line 210a/210b is surrounded by the magnetic sheet 211a/211b, the permeability may increase by the permeability of the magnetic sheet 211b.

The magnetic sheet 211a/211b may include a magnetic substance and an adhesive substance, and a ferrite sheet, a magnetic powder, and the like may be used as the magnetic sheet 211a/211b. A magnetic substance of the magnetic sheet 211a/211b has own loss. For this reason, a thickness of the magnetic sheet 211a/211b may be determined in the light of such a characteristic. In example embodiments, a thickness of a magnetic substance of the magnetic sheet 211a/211b may be 0.1 mm to 0.7 mm in the light of loss when a resonant frequency is set to 1 MHz.

At this time, the permeability of the magnetic sheet 211a/211b may be 50 to 100 under the condition of 1 MHz. In this case, a loss value of the magnetic sheet 211a/211b may be suitable to be less than 0.01.

FIG. 6 is a graph illustrating relationship between inductance and a diameter of a copper line according to how much a copper line is surrounded by a magnetic sheet using a ferrite sheet. In the event that a ferrite sheet is not used, inductance of a copper line may be less than 275 nH. The inductance of the copper line may increase up to 411 nH when the ferrite sheet is applied to one side of the copper line and up to 1100 nH when the ferrite sheet is applied to both sides of the copper line.

Compared with a magnetic sheet having the permeability of more than 10, the permeability may increase slightly. The reason is that a magnetic sheet is perfectly adhered with a copper line due to a thickness of an adhesive substance existing at the magnetic sheet. The inventive concept is described using an example that one side or both sides of a copper line are closed by a magnetic sheet. However, the inventive concept is not limited thereto. A magnetic sheet 211 and a copper line 210 may be perfectly adhered by burying the copper line 210 at a groove formed at the magnetic sheet 211 so as to correspond to a thickness of the copper line 210.

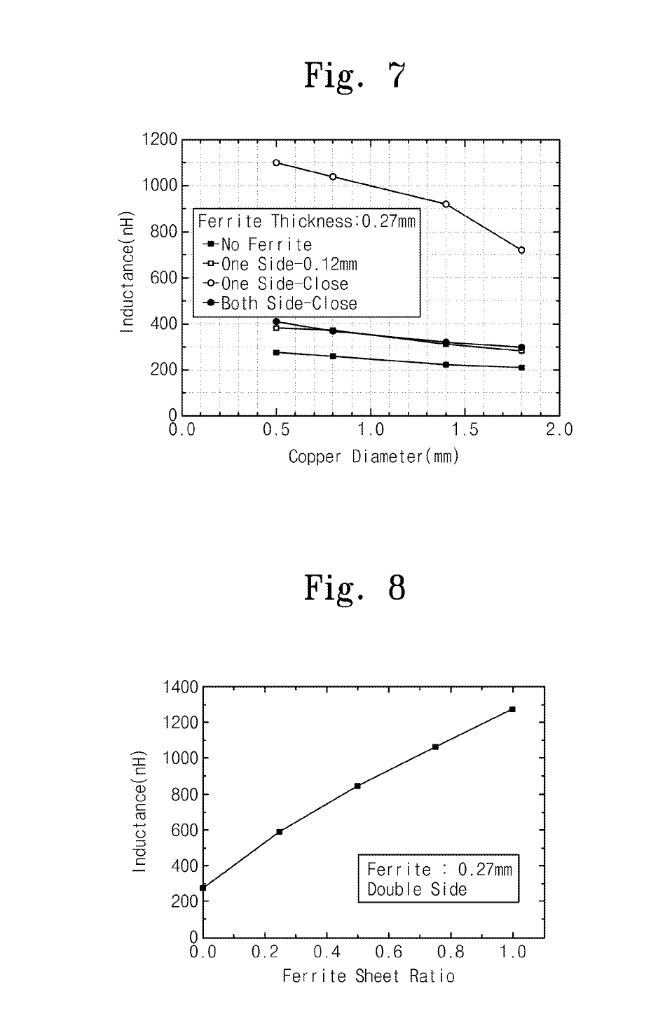

FIG. 7 is a graph illustrating a variation in inductance of a copper line according to how much a copper line is closed by a magnetic sheet. In the event that a ferrite sheet is not used, inductance of a copper line may be less than 275 nH. The inductance of the copper line may be 587 nH when a quarter of the copper line is closed by the magnetic sheet. The inductance of the copper line may be 844 nH when two quarters of the copper line is closed by the magnetic sheet. The inductance of the copper line may be 1060 nH when three quarters of the copper line is closed by the magnetic sheet. The inductance of the copper line may be 1270 nH when all of the copper line is closed by the magnetic sheet. That is, inductance of the copper line may increase linearly according to a length of the copper line that is closed by the magnetic sheet. Thus, inductance of the copper line may be adjusted in real time by varying a length of the copper line that is closed by the magnetic sheet.

FIG. 8 is a conceptual diagram illustrating a frequency adjusting unit in FIG. 2 according to another embodiment of the inventive concept.

Referring to FIG. 8, a frequency adjusting unit 323 may include a capacitor 312 for adjusting capacitance of a coil. The frequency adjusting unit 323 in FIG. 8 may be substantially the same as that in FIG. 3 except that the capacitor 312 is added, and description thereof is thus omitted. The capacitor 312 may be connected to a copper line 310. The capacitor 312 may be formed to have a withstand voltage of more than 1 kV and a small size for prevention of leakage and minimization of size. Since inductance of a coil is adjusted by a magnetic sheet 311, a capacitor 312 having an excessive size may not be required.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A wireless power receiving device comprising:
a receiving coil configured to receive a non-radiated electromagnetic wave; and
a frequency adjusting unit configured to adjust a resonant frequency of the receiving coil,
wherein the frequency adjusting unit adjusts a resonant frequency of the receiving coil by closing a surroundings of the receiving coil by a magnetic sheet.

2. The wireless power receiving device of claim 1, further comprising:
a load coil supplied with energy stored at the receiving coil by magnetic induction.

3. The wireless power receiving device of claim 1, wherein the frequency adjusting unit includes a capacitor connected to the receiving coil.

4. The wireless power receiving device of claim 1, wherein the receiving coil has a copper line to generate a magnetic field, and the copper line is buried at a groove of the magnetic sheet.

5. The wireless power receiving device of claim 1, wherein the receiving coil has a copper line to generate a magnetic field, and the frequency adjusting unit adjusts a contact area between the copper line and the magnetic sheet.

6. The wireless power receiving device of claim 5, wherein the frequency adjusting unit linearly adjusts a contact area between the copper line and the magnetic sheet.

7. The wireless power receiving device of claim 1, wherein the magnetic sheet is formed of a bilayer including an adhesive substance and a magnetic substance.

8. The wireless power receiving device of claim 7, wherein the magnetic substance is formed of ferrite.

9. A wireless power transmitting device comprising:
a transmission coil configured to generate a non-radiated electromagnetic wave by magnetic induction; and
a frequency adjusting unit configured to adjust a resonant frequency of the transmission coil,
wherein the frequency adjusting unit adjusts a resonant frequency of the transmission coil by inserting a magnetic sheet in the transmission coil.

10. The wireless power transmitting device of claim 9, wherein the wireless power transmitting device includes a power coil receiving a power, wherein the power coil resonates with the transmission coil by magnetic induction.

11. The wireless power transmitting device of claim 9, wherein the frequency adjusting unit includes a capacitor connected to the transmission coil.

12. The wireless power transmitting device of claim 9, wherein the transmission coil has a copper line generating a magnetic field, and the copper line is buried at a groove of the magnetic sheet.

13. The wireless power transmitting device of claim 9, wherein the transmission coil has a copper line generating a magnetic field, and a contact area between the magnetic sheet and the copper line is adjustable.
